(19) United States
(12) Patent Application Publication
(10) Pub. No.: US 2024/0247127 A1
(43) Pub. Date: Jul. 25, 2024

(54) FLUORINE-CONTAINING ELASTOMER COMPOSITION

(71) Applicant: UNIMATEC CO., LTD., Tokyo (JP)

(72) Inventors: Yusuke MURAKAMI, Ibaraki (JP); Hiroyuki SANO, Ibaraki (JP)

(73) Assignee: UNIMATEC CO., LTD., Tokyo (JP)

(21) Appl. No.: 18/411,874

(22) Filed: Jan. 12, 2024

(30) Foreign Application Priority Data
Jan. 17, 2023 (JP) 2023-004831

(51) Int. Cl. C08K 5/3437; C08F 214/26; C08K 5/23; C08K 5/33; C08K 5/3447; C08K 5/3462; C09D 7/41; C09D 127/18; C09K 3/10

(52) U.S. Cl. CPC C08K 5/3437; C08F 214/262; C08K 5/235; C08K 5/33; C08K 5/3447; C08K 5/3462; C09D 7/41; C09D 127/18; C09K 3/1009; C08F 2800/10; C09K 2200/047; C09K 2200/0476; C09K 2200/0637

(57) ABSTRACT

A fluorine-containing elastomer composition comprising 0.4 to 4.0 parts by weight of a pigment that is a perylene-based compound, a naphthalenecarboxamide-based compound, a pyrimidinetrione-based compound, or a benzimidazolone-based compound, and 0.2 to 5.0 parts by weight of a bisamidoxime compound or 2,2-bis(3-amino-4-hydroxyphenyl)hexafluoropropane, based on 100 parts by weight of a fluorine-containing elastomer having a copolymer composition of (A) 60.0 to 80.0 mol % of tetrafluoroethylene, (B) 19.8 to 39.8 mol % of perfluoro(lower alkyl vinyl ether) or perfluoro(lower alkoxy lower alkyl vinyl ether), and (C) 0.2 to 5.0 mol % of a perfluoro unsaturated nitrile compound.

### TECHNICAL FIELD

The present invention relates to a fluorine-containing elastomer composition. More particularly, the present invention relates to a fluorine-containing elastomer composition that can be suitably used as a molding material for plasma irradiation applications, such as seals for semiconductor production equipment.

### BACKGROUND ART

Seals for semiconductor manufacturing devices are applied as surface sealing that are used, for example, in process chambers for performing an etching process or for treatments, such as formation of thin films, on the surfaces of silicon wafers, which are semiconductor substrates. The seals are required to have heat resistance, low gas permeability, low dust characteristics (little generation of dust from seals), and other properties. In the etching process of silicon wafers, plasma irradiation is performed under the atmosphere of oxygen or CF₄, and therefore the gas (oxygen or halogen) becomes an excited state. As a result, the seals for semiconductor manufacturing devices have problems that they become vulnerable to deterioration; the surfaces of the seals become brittle; and the deteriorated materials and embrittled materials are dispersed and attached to the silicon wafers.

Meanwhile, in semiconductor manufacturing devices, cyano group-containing perfluoroelastomers and the like having excellent heat resistance are used to meet the demand for use of the seals at temperatures as high as 300° C. On the other hand, inorganic fillers, such as silica, barium sulfate, alumina, and aluminum silicate, are added for the improvement of plasma resistance, and the addition of these inorganic fillers is effective in suppressing weight loss in a plasma irradiation environment. However, the presence of elements, such as titanium, barium, and aluminum, themselves is disliked in the semiconductor industry, and materials that minimize the use of inorganic fillers are preferred.

Here, fluorinated fluoroelastomers, such as a vinylidene fluoride [VdF]/hexafluoropropylene [HFP] copolymer and a VdF/HFP/tetrafluoroethylene [TFE] terpolymer, and perfluorinated perfluoroelastomers, such as a TFE/perfluoromethyl vinyl ether [PMVE] copolymer, which are fluorine-containing elastomers, have superior performance in terms of heat resistance, chemical resistance, and the like compared to other rubbers, and are thus widely used as molding materials for sealing materials, such as O-rings, gaskets, and packings, in various industrial fields including automobiles.

Among these, perfluoroelastomers that are polymers of TFE, HFP, PMVE, etc., which are perfluoromonomers, have superior heat resistance and chemical resistance compared to fluorine-containing elastomers other than perfluoroelastomers, and are suitable as O-rings for use in semiconductor production equipment. However, simply crosslinking perfluoropolymers cannot ensure sufficient heat resistance, and for this reason, a filler that supplements radicals, such as carbon black, is compounded therein. However, on the other hand, in consideration of plasma resistance, such a filler acts as a foreign substance and becomes a source of contamination. Thus, there are restrictions, such as application only to areas that are not directly exposed to plasma.

In response to such restrictions, the present applicant has previously proposed, as a cyano group-containing perfluoroelastomer (fluorine-containing elastomer) having excellent heat resistance and usable in high-temperature environments of semiconductor production equipment and as a vulcanizing agent therefor, a fluorine-containing elastomer composition comprising 0.2 to 5 parts by weight of a bisamidoxime compound as a vulcanizing agent based on 100 parts by weight of a fluorine-containing elastomer having a copolymer composition of (A) 72.8 to 74.0 mol % of tetrafluoroethylene, (B) 26.8 to 24.0 mol % of perfluoro(lower alkyl vinyl ether) or perfluoro(lower alkoxy lower alkyl vinyl ether), and (C) 0.2 to 3.0 mol % of a perfluoro unsaturated nitrile compound (Patent Document 1).

In the invention disclosed here, plasma resistance is ensured by increasing the TFE content to 72.8 to 74.0 mol %, whereas the rubber hardness becomes extremely hard, and there is a high possibility of problems occurring during assembly. In general, the desired hardness (Duro A, PEAK) for assembly is 75 or less.

Moreover, in general, a guideline of the service life of an O-ring is a compression set of 70% or less, preferably 50% or less, after 500 hours at a target temperature of 300° C.; however, what is disclosed therein is only the value (Shore A hardness) at 300° ° C. or 315° ° C. for 70 hours.

Patent Document 2 discloses a fluororubber composition comprising (a) a peroxide-crosslinkable tetrafluoroethylene-perfluoro(alkyl vinyl ether) copolymer elastomer or vinylidene fluoride-hexafluoropropene-based copolymer elastomer obtained by copolymerization reaction of a fluorine-containing olefin in the presence of a bromine and/or iodine-containing crosslinking point forming compound, (b) an organic peroxide crosslinking agent, (c) a polyfunctional unsaturated compound co-crosslinking agent, and (d) a triallyl isocyanurate polymer, wherein the composition does not contain carbon black and a metal-containing filler. This fluororubber composition is said to provide a vulcanizate with good vulcanizate properties. However, judging from the compression set value of the vulcanizate at 200° ° C. for 70 hours or the air aging test results at 250° C. for 70 hours shown in the Examples thereof, it is difficult to say that it has sufficient heat resistance at 300° C. required for semiconductor applications etc.

On the other hand, Patent Document 3 discloses a fluorine-containing elastomer composition comprising 0.5 to 20 parts by weight of at least one of an isoindolinone-based pigment, a quinacridone-based pigment, a diketopyrrolopyrrole-based pigment, and an anthraquinone-based pigment, based on 100 parts by weight of a fluorine-containing elastomer, wherein the fluorine-containing elastomer composition improves the plasma resistance of vulcanized products. However, since the compression set rate was measured at 200° C. for 70 hours, it is difficult to say that the heat resistance is sufficient not only at 300° C. or more but also near 250° C.

### PRIOR ART DOCUMENT

### Patent Document

Patent Document 1: JP-A-2009-161662
Patent Document 2: JP-A-2005-344074
Patent Document 3: JP-B-4720501
Patent Document 4: JP-A-2013-216771
Patent Document 5: JP-B-3082626
Patent Document 6: WO 2008/041557 A1

### OUTLINE OF THE INVENTION

### Problem to be Solved by the Invention

An object of the present invention is to provide a fluorine-containing elastomer composition using a fluorine-containing elastomer having a cyano group as a crosslinkable group, a molded vulcanizate of which exhibits excellent heat resistance even under high temperature conditions, such as 300° C. or more.

### Means for Solving the Problem

The above object of the present invention can be achieved by a fluorine-containing elastomer composition comprising 0.4 to 4.0 parts by weight of a pigment that is a perylene-based compound, a naphthalenecarboxamide-based compound, a pyrimidinetrione-based compound, or a benzimidazolone-based compound, and 0.2 to 5.0 parts by weight of a bisamidoxime compound or 2,2-bis(3-amino-4-hydroxyphenyl)hexafluoropropane, based on 100 parts by weight of a fluorine-containing elastomer having a copolymer composition of (A) 60.0 to 80.0 mol % of tetrafluoroethylene, (B) 19.8 to 39.8 mol % of perfluoro(lower alkyl vinyl ether) or perfluoro(lower alkoxy lower alkyl vinyl ether), and (C) 0.2 to 5.0 mol % of a perfluoro unsaturated nitrile compound.

### Effect of the Invention

The fluorine-containing elastomer composition according to the present invention exhibits an excellent effect that a vulcanized molded article of a fluorine-containing elastomer having a cyano group as a crosslinkable group is used under plasma irradiation conditions and exhibits excellent heat resistance even under high temperature conditions, such as 300° C. or more.

### EMBODIMENTS FOR CARRYING OUT THE INVENTION

As the perfluoroelastomer containing a cyano group as a crosslinkable group:
(A) 60.0 to 80.0 mol %, preferably 60.0 to 68.8 mol % of tetrafluoroethylene, (B) 19.8 to 39.8 mol %, preferably 30.7 to 39.5 mol % of perfluoro(lower alkyl vinyl ether) or perfluoro(lower alkoxy lower alkyl vinyl ether), and (C) 0.2 to 5.0 mol %, preferably 0.5 to 3.0 mol % of a perfluoro unsaturated nitrile compound, are used. Such a perfluoroelastomer can provide a vulcanized molded article that has excellent heat resistance at a high temperature of 300° C. or more. Here, “lower alkoxy” or “lower alkyl” in each term indicates alkoxy group or alkyl group having 1-5 carbon atoms, respectively.

If the copolymerization ratio of tetrafluoroethylene as the component (A) is lower than this range, heat resistance is inferior, and rubber hardness is reduced. In contrast, if the copolymerization ratio is higher than this range, it shows resin-like behavior rather than elastomer; thus, sealing performance is reduced, processability is reduced, and rubber hardness increases to cause problems during assembly.

If the copolymerization ratio of perfluoro(lower alkyl vinyl ether) or perfluoro(lower alkoxy lower alkyl vinyl ether) as the component (B) is lower than this range, the copolymerization ratio of tetrafluoroethylene relatively increases, and the copolymer becomes almost like a resin; thus, sealing performance is reduced, processability is reduced, and rubber hardness increases to cause problems during assembly. In contrast, if the copolymerization ratio is higher than this range, rubber hardness is reduced.

As comonomer Component (B), i.e., perfluoro(lower alkyl vinyl ether), generally, perfluoro(methyl vinyl ether), perfluoro(ethyl vinyl ether), perfluoro(propyl vinyl ether), and the like are used. Moreover, as perfluoro(lower alkoxy-lower alkyl vinyl ether), for example, the following compounds are used:

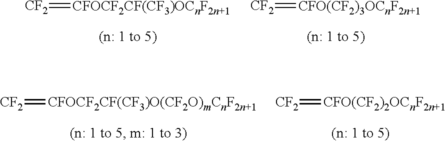

Among these, those in which the CₙF₂ₙ₊₁ group is CF₃ are particularly preferably used.

Moreover, as comonomer Component (C), i.e., perfluoro unsaturated nitrile compound, which is a crosslinking site monomer, the following compounds are used:

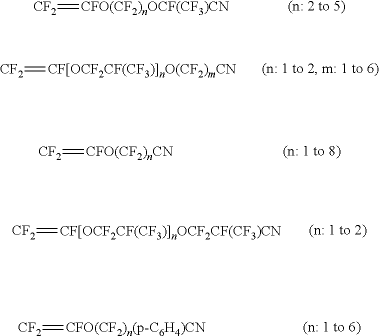

The copolymerization amount of perfluoro unsaturated nitrile compound as Component (C) is 0.2 to 5.0 mol %, and preferably 0.5 to 3.0 mol %, which are necessary amounts as a crosslinkable group.

The copolymerization reaction of these monomers is generally carried out as follows. Water, a fluorine-containing emulsifier such as ammonium perfluorooctanoate, and a buffer such as potassium dihydrogen phosphate are charged in a stainless steel autoclave. Then, tetrafluoroethylene, perfluoro(lower alkyl vinyl ether) or perfluoro(lower alkoxy-lower alkyl vinyl ether), and a perfluoro unsaturated nitrile compound are added. After the temperature is raised to about 50 to 80° C., a redox system initiator consisting of a radical generator such as ammonium persulfate and a reducing agent such as sodium sulfite are added. The reaction pressure is preferably maintained at about 0.75 to 0.85 MPa. Accordingly, in order to increase the reactor internal pressure, which drops with the progress of the reaction, it is preferably to perform the reaction while additionally adding a mixture of these three monomers in several batches.

The perfluoroelastomer terpolymer comprising the above components as essential components can be copolymerized with other fluorinated olefins, various vinyl compounds, etc., in an amount that does not inhibit the copolymerization reaction and that does not impair vulcanizate physical properties (about 20 mol % or less). Examples of other fluorinated olefins include vinylidene fluoride, monofluoroethylene, trifluoroethylene, trifluoropropylene, pentafluoropropylene, hexafluoropropylene, hexafluoroisobutylene, chlorotrifluoroethylene, and dichlorodifluoroethylene, and the like. Examples of vinyl compounds include ethylene, propylene, 1-butene, isobutylene, methyl vinyl ether, ethyl vinyl ether, butyl vinyl ether, cyclohexyl vinyl ether, vinyl acetate, vinyl propionate, vinyl chloride, vinylidene chloride, and trifluorostyrene, and the like.

The fluorine-containing elastomer comprising such a terpolymer have a copolymerization composition of (A) 60.0 to 80.0 mol % of tetrafluoroethylene, (B) 19.8 to 39.8 mol % of perfluoro(lower alkyl vinyl ether) or perfluoro(lower alkoxy lower alkyl vinyl ether), and (C) 0.2 to 5.0 mol % of a perfluoro unsaturated nitrile compound.

A fluorine-containing elastomer composition comprising 0.4 to 4.0 parts, preferably 0.8 to 3.5 parts, more preferably 1.0 to 3.0 parts by weight of a pigment that is a perylene-based compound, a naphthalenecarboxamide-based compound, a pyrimidinetrione-based compound, or a benzimidazolone-based compound, based on 100 parts by weight of the fluorine-containing elastomer. If the pigment is used at a ratio less than the above range, the heat resistance under high temperature conditions, such as 300° C. or more, becomes inferior. In contrast, if the pigment is used at a ratio greater than the above range, dispersibility becomes insufficient, and as a result, visible aggregates are formed, which can serve as starting points of fracture.

Usable examples of the perylene-based compound include Pigment violet 29 (3,4,9,10-perylenetetracarboxylic acid diimide), Pigment Red 123, Pigment Red 149, Pigment Red 178, Pigment Red 179, Pigment Red 190, Pigment Red 224, Pigment Orange 240, Pigment Black 31, and the like; preferably a perylene-based compound having an imide group, for example, the following compound:

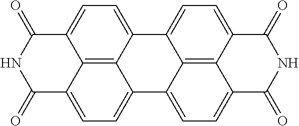 [SMILES: O=C1NC(=O)c2ccc3c4ccc5c6c(ccc(c7ccc1c2c73)c64)C(=O)NC5=O]

is used.

Usable examples of the naphthalenecarboxamide-based compound include Pigment Red 146, Pigment Red 166, Pigment Red 242, Pigment Yellow 13, Pigment Yellow 83, and the like; preferably a naphthalenecarboxamide-based compound having a phenylazo group, for example, the following compound:

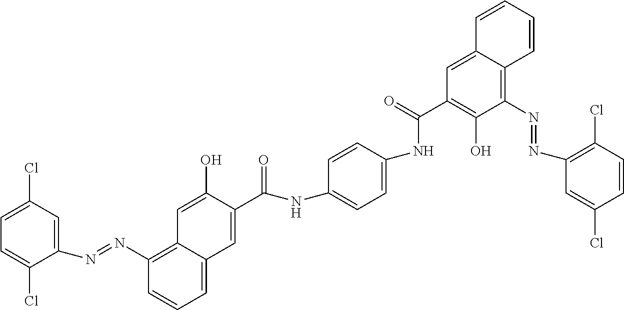 [SMILES: O=C(Nc1ccc(NC(=O)c2cc3ccccc3c(/N=N/c3cc(Cl)ccc3Cl)c2O)cc1)c1cc2cccc(/N=N/c3cc(Cl)ccc3Cl)c2cc1O]

is used.

Usable examples of the pyrimidinetrione-based compound include Pigment Orange 64, Pigment Yellow 139, and the like; preferably a pyrimidinetrione-based compound having a benzimidazole group, for example, the following compound:

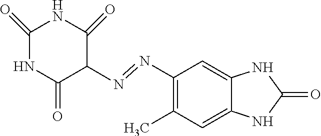 [SMILES: Cc1cc2[nH]c(=O)[nH]c2cc1/N=N/C1C(=O)NC(=O)NC1=O]

is used.

Usable examples of the benzimidazolone-based compound include Pigment Yellow 151, Pigment Yellow 154, Pigment Yellow 180, Pigment Yellow 181, Pigment Yellow 192, and the like; preferably a benzimidazolone-based compound having an isoquinoline group, for example, the following compound:

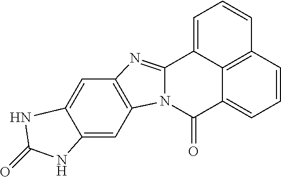 [SMILES: O=c1[nH]c2cc3nc4c5cccc6cccc(c(=O)n4c3cc2[nH]1)c65]

is used.

Patent Document 4 discloses a perfluoroelastomer composition comprising 100 parts by weight of a perfluoroelastomer having a cyano group as a crosslinkable group, compounded with 0.2 to 5 parts by weight of a bisamidoxime compound vulcanizing agent, which is also used in the present invention as a vulcanizing agent, and 0.005 to 0.3 parts by weight of a coloring agent having a melting point of 300° C. or more, wherein quinacridone is referred to as the coloring agent. In the invention disclosed in this patent document, quinacridone is added only for the purpose of coloring, the Examples merely show an embodiment in which 0.1 parts by weight thereof, which is less than the amount specified in the present invention, is used, and the technical idea of the present invention, which aims to improve heat resistance, is not disclosed therein. Further, in the invention disclosed in this patent document, due to the TFE content as high as 74.0 mol %, it is extremely hard with a rubber hardness of 80 or more, which problematically leads to a high possibility of problems occurring during assembly. As described above, the desired hardness (Duro A, PEAK) for assembly is generally 75 or less.

In the fluorine-containing elastomer, as described in Patent Documents 5 and 6, a bisamidoxime compound represented by the general formula:

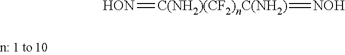

or 2,2-bis(3-amino-4-hydroxyphenyl)hexafluoropropane is used as a vulcanizing agent and added at a ratio of 0.2 to 5 parts by weight, preferably 0.5 to 2 parts by weight, based on 100 parts by weight of the fluorine-containing elastomer.

The preparation of the fluorine-containing elastomer composition comprising the above essential components is performed by kneading with two-rolls, or the like, at about 30 to 100° ° C. The crosslinking of the composition is performed by heating at about 100 to 250° ° C. for about 10 to 120 minutes. When secondary vulcanization is performed, it is performed at about 90 to 300° C., and oven vulcanization is preferably performed with a gradual temperature increase, as described in the following Examples.

### EXAMPLES

Next, the present invention will be described in detail with reference to Examples. The present invention, including its effects, is not limited to the Examples.

### Example 1

Based on 100 parts by weight of a copolymer comprising a copolymer composition of TFE/PMVE/perfluoro(3-oxa-8-cyano-1-octene) [CPeVE; CF₂═CFO(CF₂)₄CN]=65.4/33.3/1.3 mol %, 0.4 parts by weight of 3,4,9,10-perylenetetracarboxylic acid diimide, which is the following perylene-based pigment (Pigment violet 29):

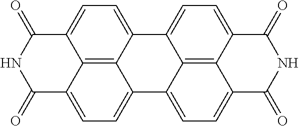 [SMILES: O=C1NC(=O)c2ccc3c4ccc5c6c(ccc(c7ccc1c2c73)c64)C(=O)NC5=O]

and 1.4 parts by weight of a bisamidoxime compound [HON═C(NH₂)(CF₂)₄C(NH₂)═NOH] were added, and the mixture was kneaded on a two-roll mill at a temperature of 30 to 100° C. After the kneaded product was subjected to press vulcanization (primary vulcanization) at 180ºC for 30 minutes, oven vulcanization (secondary vulcanization) was performed in a nitrogen gas atmosphere under the following conditions.
Left at 90° ° C. for 4 hours.
Temperature was raised from 90° ° C. to 204° C. over 6 hours.
Left at 204° C. for 18 hours.
Temperature was raised from 204° C. to 298° C. over 3 hours.
Left at 298° C. for 8 hours.

For the obtained vulcanized molded article, the measurement of normal state physical properties, the measurement of compression set, and the confirmation of dispersibility were carried out.
Normal state physical properties: JIS K-6253-3 corresponding to ASTM D2240 (hardness)
   JIS K-6251 corresponding to ISO 37
   (tensile testing)
   Hardness is preferably 75 or less
Compression set: ASTM Method B; measured using a P-24 O ring at 300° C. for 168, 336 or 500 hours
   Compression set is preferably 50% or less at 300° ° C. for 500 hours
Dispersibility: After kneading on a two-roll mill, the kneaded product was formed into a sheet with a thickness of 2 mm, and pigment aggregates visually observed in 1 kg of the kneaded product were counted.
   Since aggregates could serve as starting points of fracture, 5 or fewer aggregates were evaluated as ◯, and 6 or more aggregates were evaluated as x.

### Example 2

In Example 1, the amount of the 3,4,9,10-perylenetetracarboxylic acid diimide was changed to 1 part by weight.

### Example 3

In Example 1, the amount of the 3,4,9,10-perylenetetracarboxylic acid diimide was changed to 3 parts by weight.

### Comparative Example 1

In Example 1, the amount of the 3,4,9,10-perylenetetracarboxylic acid diimide was changed to 5 parts by weight.

### Example 4

In Example 1, the same amount (0.4 parts by weight) of following naphthalenecarboxamide-based pigment (Pigment Red 166) was used in place of perylene-based pigment.

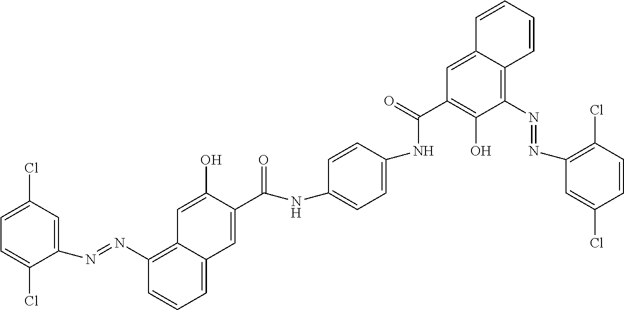 [SMILES: O=C(Nc1ccc(NC(=O)c2cc3ccccc3c(/N=N/c3cc(Cl)ccc3Cl)c2O)cc1)c1cc2cccc(/N=N/c3cc(Cl)ccc3Cl)c2cc1O]

### Example 5

In Example 4, the amount of the naphthalenecarboxamide-based pigment was changed to 1 part by weight.

### Example 6

In Example 4, the amount of the naphthalenecarboxamide-based pigment was changed to 3 parts by weight.

### Comparative Example 2

In Example 4, the amount of the naphthalenecarboxamide-based pigment was changed to 5 parts by weight.

### Example 7

In Example 1, the same amount (0.4 parts by weight) of following pyrimidinetrione-based pigment (Pigment Orange 64) was used in place of perylene-based pigment.

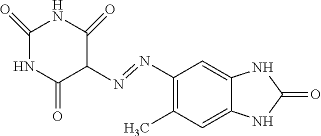 [SMILES: Cc1cc2[nH]c(=O)[nH]c2cc1/N=N/C1C(=O)NC(=O)NC1=O]

### Example 8

In Example 7, the amount of the pyrimidinetrione-based pigment was changed to 1 part by weight.

### Example 9

In Example 7, the amount of the pyrimidinetrione-based pigment was changed to 3 parts by weight.

### Comparative Example 3

In Example 7, the amount of the pyrimidinetrione-based pigment was changed to 5 parts by weight.

### Example 10

In Example 1, the same amount (0.4 parts by weight) of following benzimidazolone-based pigment (Pigment Yellow 192) was used in place of perylene-based pigment.

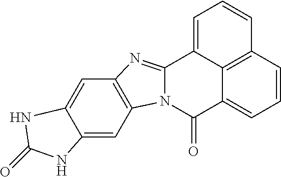 [SMILES: O=c1[nH]c2cc3nc4c5cccc6cccc(c(=O)n4c3cc2[nH]1)c65]

### Example 11

In Example 10, the amount of the benzimidazolone-based pigment was changed to 1 part by weight.

### Example 12

In Example 10, the amount of the benzimidazolone-based pigment was changed to 3 parts by weight.

### Comparative Example 4

In Example 10, the amount of the benzimidazolone-based pigment was changed to 5 parts by weight.

### Comparative Example 5

In Example 1, perylene-based pigment was not used.

The results obtained in the above Examples and Comparative Examples are shown in the following Table.

TABLE

| | | | | | Comp. | | | | Comp. | |
|---|---|---|---|---|---|---|---|---|---|---|
| Measurement item | | Ex. 1 | Ex. 2 | Ex. 3 | Ex. 1 | Ex. 4 | Ex. 5 | Ex. 6 | Ex. 2 | Ex. 7 |
| Normal state physical properties | | | | | | | | | | |
| Hardness(Duro A) | (pts) | 68 | 68 | 69 | 72 | 69 | 69 | 71 | 73 | 68 |
| 100% modulus | (MPa) | 2.52 | 2.71 | 3.33 | 4.03 | 2.50 | 2.66 | 3.18 | 3.75 | 2.52 |
| Breaking strength | (MPa) | 17.9 | 17.5 | 16.9 | 15.5 | 15.5 | 19.4 | 16.3 | 15.1 | 13.2 |
| Elongation at break | (%) | 240 | 240 | 240 | 240 | 230 | 240 | 250 | 240 | 220 |
| Compression set (300° C.) | | | | | | | | | | |
| 168 hours | (%) | 17 | 17 | 21 | 33 | 21 | 25 | 44 | 53 | 19 |
| 300 hours | (%) | 24 | 22 | 27 | 37 | 25 | 29 | 47 | 57 | 25 |
| 500 hours | (%) | 33 | 28 | 34 | 44 | 32 | 34 | 51 | 60 | 49 |
| Dispersibility | | ∘ | ∘ | ∘ | x | ∘ | ∘ | ∘ | x | ∘ |

| | | | | Comp. | | | | Comp. | Comp. |
|---|---|---|---|---|---|---|---|---|---|
| Measurement item | | Ex. 8 | Ex. 9 | Ex. 3 | Ex. 10 | Ex. 11 | Ex. 12 | Ex. 4 | Ex. 5 |
| Normal state physical properties | | | | | | | | | |
| Hardness(Duro A) | (pts) | 68 | 70 | 72 | 68 | 68 | 70 | 73 | 69 |
| 100% modulus | (MPa) | 2.69 | 3.29 | 3.99 | 2.53 | 2.65 | 3.15 | 3.79 | 2.25 |
| Breaking strength | (MPa) | 16.0 | 20.1 | 21.5 | 14.3 | 14.8 | 12.9 | 14.2 | 20.8 |
| Elongation at break | (%) | 230 | 240 | 250 | 220 | 230 | 230 | 230 | 240 |
| Compression set (300° C.) | | | | | | | | | |
| 168 hours | (%) | 23 | 32 | 42 | 19 | 25 | 34 | 41 | adhesion |
| 300 hours | (%) | 26 | 34 | 44 | 25 | 30 | 43 | 47 | — |
| 500 hours | (%) | 32 | 39 | 47 | 26 | 35 | 50 | 58 | — |
| Dispersibility | | ∘ | ∘ | x | ∘ | ∘ | ∘ | x | ∘ |

### INDUSTRIAL APPLICABILITY

Sealing materials, such as O-rings, obtained by vulcanization molding of the fluorine-containing elastomer composition used in the present invention have excellent heat resistance even under high temperature conditions, such as 300° ° C. or more, and can retain excellent sealing properties.

Therefore, they are effectively used as, for example, sealing materials for gate valves in semiconductor production equipment used for plasma irradiation. Moreover, they are applied to surface sealing for silicon wafer surface treatment processing chambers, for example, the connection surface between the chambers or the joint surface between the chamber and gate (door), and can also be effectively used as O-rings, packings, or the like to maintain a vacuum.

1. A fluorine-containing elastomer composition comprising 0.4 to 4.0 parts by weight of a pigment that is a perylene-based compound, a naphthalenecarboxamide-based compound, a pyrimidinetrione-based compound, or a benzimidazolone-based compound, and 0.2 to 5.0 parts by weight of a bisamidoxime compound or 2,2-bis(3-amino-4-hydroxyphenyl)hexafluoropropane, based on 100 parts by weight of a fluorine-containing elastomer having a copolymer composition of (A) 60.0 to 80.0 mol % of tetrafluoroethylene, (B) 19.8 to 39.8 mol % of perfluoro(lower alkyl vinyl ether) or perfluoro(lower alkoxy lower alkyl vinyl ether), and (C) 0.2 to 5.0 mol % of a perfluoro unsaturated nitrile compound.

2. The fluorine-containing elastomer composition according to claim 1, wherein a fluorine-containing elastomer having a copolymer composition of (A) 60.0 to 68.8 mol % of tetrafluoroethylene, (B) 30.7 to 39.5 mol % of perfluoro(lower alkyl vinyl ether) or perfluoro(lower alkoxy lower alkyl vinyl ether), and (C) 0.5 to 3.0 mol % of a perfluoro unsaturated nitrile compound is used.

3. The fluorine-containing elastomer composition according to claim 1, wherein the pigment is a perylene-based compound having an imide group, a naphthalenecarboxamide-based compound having a phenylazo group, a pyrimidinetrione-based compound having a benzimidazole group, or a benzimidazolone-based compound having an isoquinoline group.

4. The fluorine-containing elastomer composition according to claim 3, wherein perylene-based compound having an imide group is the following compound:

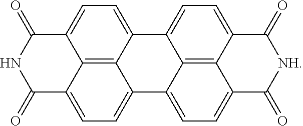 [SMILES: O=C1NC(=O)c2ccc3c4ccc5c6c(ccc(c7ccc1c2c73)c64)C(=O)NC5=O]

5. The fluorine-containing elastomer composition according to claim 3, wherein naphthalenecarboxamide-based compound having a phenylazo group is the following compound:

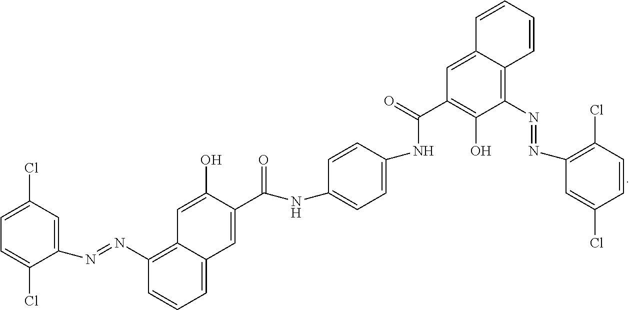 [SMILES: O=C(Nc1ccc(NC(=O)c2cc3ccccc3c(/N=N/c3cc(Cl)ccc3Cl)c2O)cc1)c1cc2cccc(/N=N/c3cc(Cl)ccc3Cl)c2cc1O]

6. The fluorine-containing elastomer composition according to claim 3, wherein pyrimidinetrione-based compound having a benzimidazole group is the following compound:

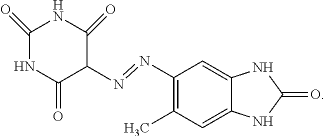 [SMILES: Cc1cc2[nH]c(=O)[nH]c2cc1/N=N/C1C(=O)NC(=O)NC1=O]

7. The fluorine-containing elastomer composition according to claim 3, wherein benzimidazolone-based compound having an isoquinoline group is the following compound:

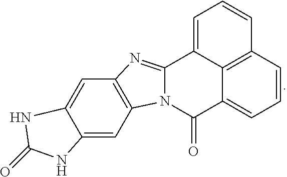 [SMILES: O=c1[nH]c2cc3nc4c5cccc6cccc(c(=O)n4c3cc2[nH]1)c65]

8. The fluorine-containing elastomer composition according to claim 1, wherein bisamidoxime compound is compound represented by the general formula: 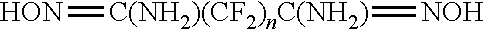
(n is an integer of 1 to 10) is used.

9. The colored vulcanized molded article of the fluorine-containing elastomer composition according to claim 1.

10. The colored vulcanized molded article according to claim 9, which has a compression set of 50% or less at 300° ° C. for 500 hours and a rubber hardness (Duro A) of 75 or less.

11. The colored vulcanized molded article according to claim 9, which is used for a sealing materials.

12. The colored sealing materials according to claim 11, which is used for plasma irradiation applications.

13. The colored sealing materials according to claim 12, which is used for semiconductor production equipment.

14. The colored sealing materials according to claim 13, which is used for surface sealing for silicon wafer surface treatment processing chambers.

15. The colored sealing materials according to claim 13, which is used for gate valves.
